(19) United States
(12) Patent Application Publication
(10) Pub. No.: US 2003/0024804 A1
(43) Pub. Date: Feb. 6, 2003

(54) Method and device for the plasma-induced lowering of the soot emission from diesel engines

(76) Inventor: Thomas Hammer, Hemhofen (DE)

Correspondence Address: LARNER AND GREENBERG, P.A., Post Office Box 2480, Hollywood, FL, 33022-2480, US

(21) Appl. No.: 10/223,534

(22) Filed: Aug. 19, 2002

Related U.S. Application Data
(63) Continuation of application No. PCT/DE01/00417, filed on Feb. 2, 2001.

(30) Foreign Application Priority Data
Feb. 17, 2000 (DE) 100 07 130.9

(51) Int. Cl. B01D 53/00

(52) U.S. Cl. 204/157.3

(57) ABSTRACT

In diesel engines, soot particles in the engine exhaust gas flow through an exhaust gas line. According to the invention, the soot particles flowing through the exhaust gas line are deposited by inertial forces onto electrodes of a reactor for producing dielectrically hindered gas discharges, the electrodes being periodically structured in the direction of flow of the exhaust gas, and are oxidized on the electrodes by the continuous action of the gas discharge. To such an end, at least one reactor for producing the dielectrically hindered discharges has metallic electrodes, which have a dielectrically active coating and an undulated or pleated structure.

### CROSS-REFERENCE TO RELATED APPLICATION

This application is a continuation of copending International Application No. PCT/DE01/00417, filed Feb. 2, 2001, which designated the United States and was not published in English.

### BACKGROUND OF THE INVENTION

Field of the Invention

The invention relates to a method for the plasma-induced lowering of the soot emission from diesel engines, in which soot particles in the engine exhaust gas flow through an exhaust section. In addition, the invention also relates to an associated device for carrying out the method.

Recent studies have shown that soot that reaches the lungs is harmful to health and possibly even carcinogenic. However, in particular, the direct injection diesel engines used for passenger automobiles, which are of interest for reasons of fuel economy, emit particles that reach the lungs. One solution to the problem, which has long been under investigation, could lie in regeneratable particle filters that, however, for regeneration at low exhaust temperatures require an additive, such as, for example, cerium, Na—Sr mixture, or Fe—Sr mixture in the fuel, which acts as a catalyst for the oxidation of soot. Such catalysts act, for example, by, first of all, being oxidized themselves and then transferring oxygen to the soot. In practical use, however, the oxides are only partially oxidized by the soot. Thus, in long-term operation, there is a problem with catalyst ash blocking the filter.

The latter problem is particularly pronounced in the case of sulfur-containing fuels, on account of the formation of sulfate. Purely thermal regeneration is not feasible because, to do so, engine operating points in which the exhaust-gas temperature is greatly increased have to be set for a short period. Such measures may lead to the soot filter burning through locally, causing it to be destroyed.

The prior art has already proposed or investigated various plasma processes, which can be classified as follows:

a) particles are electrically charged by treatment with a spray discharge, are electrostatically deposited, and are oxidized on the substrate by plasma processes, if appropriate, with the addition of a catalyst in the fuel or in the substrate (European Patent Application EP 0 332 609 B1, corresponding to U.S. Pat. No. 4,979,364 to Fleck, and International publication WO 91/03631 A);

b) particles are agglomerated by treatment with a spray discharge and are deposited by a cyclone, where they are disposed of, for example, thermally (German Published, Non-Prosecuted Patent Application DE 34 24 196 A1, corresponding to U.S. Pat. No. 4,649,703 to Dettling et al.);

c) particles are deposited in a dielectric fixed bed including granules, in a fiber composite (felt), or in a porous material (ceramic foam or the like) as a filter. A non-thermal plasma is burnt in such a porous structure, continuously regenerating the surfaces (International publication WO 99/38603 A, corresponding to United States Patent Publication 2001/34461 A1 to Segal);

d) plasma-induced regeneration of soot filters can also be achieved if, in a non-thermal plasma, NO is oxidized to form NO₂, which, even at low temperatures, is reduced again to form NO, with the soot being oxidized. Given sufficient exhaust-gas temperatures, it is also possible to use an oxidation catalyst instead of the plasma (continuously regenerated trap (CRT) system);

e) a further process for lowering the particle emission is described in U.S. Pat. No. 5,698,012 to Yoshikawa, and in U.S. Pat. No. 5,492,677 to Yoshikawa, in which it is provided for the soot particles to be negatively electrically charged at a first grid electrode, to which voltages of between −12 V and −500 V are applied, and to be deposited at the counterelectrode, which is constructed, for example, in the form of a carbon fiber felt. Compared to corona processes, such a process is supposed to allow a compact, simple structure for use in motor vehicles.

European Patent Application EP 0 658 685 A1 discloses an electrostatic dust filter including alternating metallic electrodes and metallic electrodes for soot deposition that are provided with ceramic layers of defined electrical conductivity, in which soot is deposited as a result of electrostatic forces. Furthermore, German Published, Non-Prosecuted Patent Application DE 195 25 749 describes a dielectric barrier discharge (DBD) in which structures with gas discharge zones and zones in which there are no gas discharges are present to divide up the reactor along the direction of flow of the exhaust gas. However, these structures cannot be used for deposition and oxidation of soot. In addition, German Published, Non-Prosecuted Patent Application DE 198 20 682, corresponding to U.S. Pat. No. 6,247,303 to Broeer et al., discloses processes and devices for the plasma-assisted selective catalytic reduction of nitrogen oxides, but the disclosure does not involve lowering the soot emissions. In a similar way, U.S. Pat. No. 5,914,015 to Barlow et al. describes breaking down NOx by plasma and catalytic processes in a reactor provided with electrode structures and catalytic layers. In this case too, it is impossible to see any potential for such a concept to lower the levels of soot emission. U.S. Pat. No. 5,547,493 to Krigmont describes an electrostatic dust filter that does not include any special features relevant to use in motor vehicles.

The comments that follow are noted in connection with the above prior art.

The electrostatic deposition of particles requires two plasma reactors—a first reactor for electrically charging the particles proportionally to their mass, and a second reactor for electrostatic deposition and catalytic or plasma-induced oxidation.

In a compact structure that is suitable for motor vehicles, such a function cannot reliably be ensured. There is a risk of uncontrolled deposition of the particles at locations in the exhaust section at which their oxidation is not ensured. Such a disadvantageous result can lead to sudden, uncontrolled release of large quantities of particles, a phenomenon that is known as “re-entrainment” in the specialist field.

Even with electrostatic agglomeration, it is impossible to ensure that the particles are subsequently deposited in a controlled manner. This results in the same problems as those involved in electrostatic deposition dealt with above under (a).

The deposition of soot in continuously plasma-regenerated porous structures has a good effect. However, when granules or fiber material is being used, there are problems with the long-term mechanical strength of the porous structure when used in motor vehicles, or, when ceramic foams are used, there are problems with the dynamic pressure.

The continuous regeneration of soot filters by an upstream plasma works, in principle, but requires the presence of sufficient quantities of NO in the exhaust gas and is disadvantageous in terms of energy (B. M. Penetrante et al. “Feasibility of Plasma Aftertreatment for Simultaneous Control of NOx and Particulates”, SAE paper no. 1999-01-3637).

The charging of particles at a grid electrode with subsequent deposition at a carbon fiber felt or related filter materials has only a low efficiency, and the limited service life of the carbon fiber felt, which is simultaneously intended to bring about a slight reduction of the nitrogen oxide emissions, is to be regarded as an obstacle to use in a motor vehicle.

### SUMMARY OF THE INVENTION

It is accordingly an object of the invention to provide a method and device for the plasma-induced lowering of the soot emission from diesel engines that overcomes the hereinafore-mentioned disadvantages of the heretofore-known devices of this general type and that improves the process for lowering the levels of soot and provides an associated device.

With the foregoing and other objects in view, there is provided, in accordance with the invention, a method of plasma-induced lowering of soot emission, including the steps of producing soot particles in an engine exhaust gas flow of a diesel engine through an exhaust section, integrating a reactor generating dielectric barrier discharges in the exhaust section, diverting the gas flow and generating the dielectric barrier discharges by providing electrodes in the reactor, the electrodes structured periodically along the exhaust section, depositing the soot particles flowing along the exhaust section on the periodically structured electrodes as result of the diversion of the gas flow due to inertia forces, and oxidizing the soot particles deposited on the electrodes by continuous action of the gas discharges.

The invention proposes a process that firstly deposits soot on a mechanically robust structure, where it is continuously oxidized by a non-thermal plasma, and, at the same time, i.e., without a further plasma reactor being absolutely imperative, preferably allows plasma-induced catalytic reduction of the nitrogen oxides.

The method according to the invention is based on the fact that soot particles are deposited as a result of inertia on a structure that recurs a number of times in the direction of flow of the exhaust gas and is configured as a metallic, preferably dielectrically coated electrode for a dielectric barrier discharge. Then, the soot is present in high concentrations on the surfaces of these structures, where it can be efficiently oxidized by the plasma, as dealt with above under (c). Electrical field strengths of at least 1 kV/mm, typically 4 kV/mm, are required to form dielectric barrier discharges in air and in exhaust gases at atmospheric pressure and temperatures around 100° C. The structure is preferably wavy with a constant electrode spacing, wavy with recurring changes in the electrode spacing, or a folded pattern. The dielectric coatings on the electrodes may be produced by glazing, enamelling, application of ceramic pastes with subsequent calcining or sintering, and further processes that exist in the specialist field.

The invention is based on the discovery that, by using a special reactor geometry compared to the prior art, it is possible for soot to be deposited and oxidized under controlled conditions. Geometry parameters allow both the mechanical deposition of the soot particles and the properties of the gas discharge to be adjusted for oxidation of the soot. only in this way is a process made possible for lowering the levels of soot that can be carried out in a defined way and is stable over a prolonged period. A further important consideration is that the creation of a specific reactor geometry makes it possible to adjust the ratio of volume discharge to surface discharge and, therefore, to control not only the lowering of the levels of soot but also the plasma-chemical conversion of gaseous pollutants. Such a property can be used to couple the lowering of the levels of the soot to further measures for lowering the levels of pollutants, for example, by selective catalytic reduction, without additional reactors being required.

In accordance with another mode of the invention, the deposition of the soot particles on the electrodes is assisted with electrical fields.

In accordance with a further mode of the invention, the dielectric barrier gas discharges are generated with at least one of the electrodes being a metallic electrode having an electrically insulating, dielectric coating on sides thereof. Preferably, the metallic electrode has two sides and an electrically insulating, dielectric coating on the two sides.

In accordance with an added mode of the invention, the oxidation of the soot particles is assisted with catalytic coatings on the electrodes.

In accordance with an additional mode of the invention, nitrogen oxides present in the exhaust gas within the exhaust section are catalytically reduced and the catalytic reduction is promoted with the dielectric barrier gas discharges.

In accordance with yet another feature of the invention, the catalytic reduction of the nitrogen oxides is carried out in the same reactor as the oxidation of the soot particles and carbon compounds are utilized as a reducing agent.

In accordance with yet a further feature of the invention, the catalytic reduction of the nitrogen oxides is carried out in a separate catalytic reactor, and a nitrogen-containing reducing agent is added to the exhaust gas upstream of the catalytic reactor with respect to a flow direction of the engine exhaust gas flow.

With the objects of the invention in view, there is also provided a method of plasma-induced lowering of soot emission in a diesel engine producing soot particles in an engine exhaust gas flow through an exhaust section, including the steps of integrating a reactor generating dielectric barrier discharges in the exhaust section of the diesel engine, diverting the gas flow and generating the dielectric barrier discharges by providing electrodes in the reactor, the electrodes structured periodically along the exhaust section, depositing the soot particles flowing along the exhaust section on the periodically structured electrodes as result of the diversion of the gas flow due to inertia forces, and oxidizing the soot particles deposited on the electrodes by continuous action of the gas discharges.

With the objects of the invention in view, there is also provided a device for plasma-induced lowering of soot emission of an exhaust gas containing soot particles, including at least one reactor generating dielectric barrier discharges, the at least one reactor having metal electrodes with at least two sides, the metal electrodes having a dielectric material coating on each of the at least two sides and a structure running along the exhaust section for inertia deposition of the soot particles, the structure selected from the group consisting of a wavy structure and a folded structure.

In accordance with yet an added feature of the invention, the structure has preferential soot deposition locations at which an electrical field strength is increased to generate the dielectric barrier gas discharges.

In accordance with yet an additional feature of the invention, the electrodes have a planar configuration.

In accordance with again another feature of the invention, the exhaust section is circular and the electrodes are rotationally symmetrical with respect to the exhaust section.

In accordance with again a further feature of the invention, the structure is periodically recurring and is defined by structure parameters along a direction of flow of the exhaust gas.

In accordance with again an added feature of the invention, the structure parameters define physical gas discharge properties for the dielectric barrier discharges and inertia properties for the deposition of the soot particles.

In accordance with again an additional feature of the invention, the coating is of ceramic. Preferably, the ceramic is based on zirconium oxide and/or aluminum oxide. Also, the coating can be of one of the group consisting of glass and enamel.

In accordance with still another feature of the invention, a dielectric material of the coating has oxidation promoting catalytic additives. Preferably, the oxidation promoting catalytic additives are platinum or palladium.

In accordance with still a further feature of the invention, a dielectric material of the coating has catalytic additives promoting nitrogen oxide reduction, such as γ-Al₂O₃, Ag-γ-Al₂O₃.

In accordance with still an added feature of the invention, the at least one reactor is two separate reactors, a first of the reactors has a plasma-induced soot emission lowering device, and a second of the reactors has a catalytic reduction device for nitrogen oxides present in the exhaust gas.

In accordance with still an additional feature of the invention, there is provided a metering device supplying a nitrogen-containing reducing agent connected upstream of the second reactor with respect to a direction of flow of the exhaust gas.

With the objects of the invention in view, there is also provided a device for plasma-induced lowering of soot emission, including at least one reactor generating dielectric barrier discharges, the at least one reactor to be integrated into an exhaust section of a diesel engine producing soot particles in an engine exhaust gas flow, the at least one reactor having metal electrodes diverting the exhaust gas flow and generating the dielectric barrier discharges and the metal electrodes having at least two sides, a coating of dielectric material on each of the at least two sides, and one of a wavy structure and a folded structure running along the exhaust section for inertia deposition of soot on the electrodes, continuous action of the gas discharges on the exhaust gas flow oxidizing the soot particles deposited on the electrodes.

Other features that are considered as characteristic for the invention are set forth in the appended claims.

Although the invention is illustrated and described herein as embodied in a method and device for the plasma-induced lowering of the soot emission from diesel engines, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, diagrammatic, cross-sectional view of an electrode geometry for the deposition of soot and oxidation according to the invention;

FIG. 2 is a fragmentary, enlarged detail of the electrode geometry of FIG. 1;

FIG. 3 is a fragmentary, diagrammatic, cross-sectional view of an alternative embodiment of the geometry of FIG. 1 with a cylindrically, i.e., concentrically, configured reactor having structured electrodes according to the invention;

FIG. 4 is a simplified, block circuit diagram of an exhaust cleaning system using a reactor with an electrode geometry of FIGS. 1 to 3; and

FIG. 5 is a simplified, block circuit diagram of an alternative embodiment of the system of FIG. 4.

### DESCRIPTION OF THE PREFERRED EMBODIMENTS

In addition to disruptive nitrogen oxides, the exhaust gas from a diesel motor vehicle contains, in particular, soot. Both components are harmful to human health and also to the environment.

To eliminate the soot and the nitrogen oxides, the procedure is as follows: the soot is preferably oxidized in surface discharges, while in the volumetric part of the dielectric barrier discharges NO is partially oxidized to form NO₂ and hydrocarbons are also partially oxidized. The NO₂ so formed reacts, limited by the distance over which it is conveyed and, therefore—in particular, at low exhaust-gas temperatures—only to a limited extent with the deposited soot. It is, therefore, available, like the partially oxidized hydrocarbons, for catalytic processes.

M. L. Balmer et al., “NOx Destruction Behavior of Selected Materials when Combined with a Non-Thermal Plasma”, SAE paper no. 1999-01-3640 discloses the fact that both the oxidation of NO to form NO₂ and the partial oxidation of hydrocarbons can create the basic conditions for the catalytic reduction of nitrogen oxides with hydrocarbon-based reducing agents over a wide temperature range. Therefore, a significant advantage of the process comes to bear when plasma-induced catalytic reduction of the nitrogen oxides using hydrocarbon-based reducing agents is carried out simultaneously in such a reactor. This can be achieved by a catalytic coating of the electrode or dielectric with a suitable catalyst, either in the entire reactor or in the downstream part of the reactor, which is only subject to low stresses caused by soot. The catalytic coating may, for example, be γ-Al₂O₃ or Ag-γ-Al₂O₃. Further features provide for a reducing agent, such as, for example, a urea solution, to be supplied downstream of the plasma soot filter, with a subsequent catalytic converter for selective catalytic reduction (SCR) that, on account of the plasma pretreatment and the associated conversion of NO to form NO₂, can be operated at relatively low exhaust-gas temperatures or at normal operating temperature with a higher efficiency. For further details, reference is made in this context to Th. Hammer et al., “Plasma Enhanced Selective Catalytic Reduction”, SAE papers 1999-01-3632 and 1999-013633.

Unlike in the prior art, the soot deposition does not require any reactor fillings that become detached mechanically, for example, as a result of friction, in order to deposit soot.

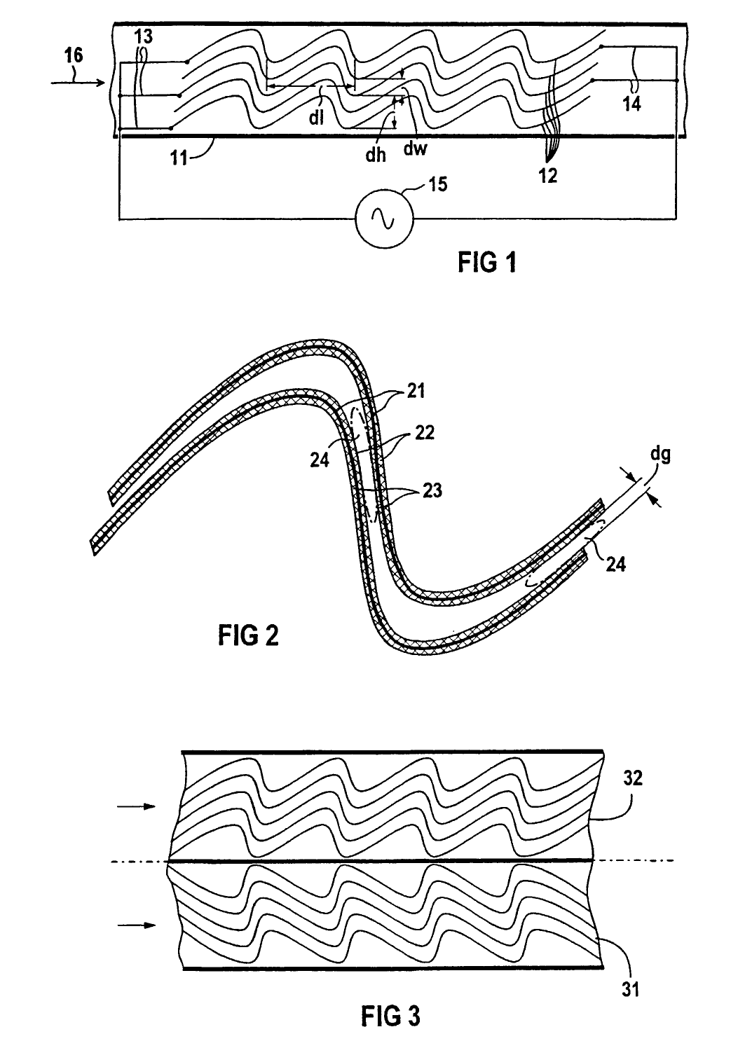

Referring now to the figures of the drawings in detail and first, particularly to FIG. 1 thereof, there is shown a first advantageous electrode geometry according to the invention. In a reactor 11 with a planar geometry, electrodes 12 are disposed at a distance dw parallel to one another, with a structure of height dh that recurs in the longitudinal direction at intervals dl. The efficiency of the mechanical soot deposition can be adjusted by suitably selecting the geometry parameters dl, dh, and dw. This is an optimization process, for which flow-dynamics model calculations can also be used. For efficient deposition of soot the height of the structure dh is greater than the electrode space dw (dh>dw). To produce dielectric barrier discharges, the electrode spacing dw is advantageously set to values between 0.5 mm and 5 mm.

To ensure that the flow resistance of the configuration does not become too great, the period length of the structure dl is selected to be greater than dh. The electrodes 12 are alternately connected to the ground connection 13 or to the high-voltage connection 14 of an alternating voltage or pulsed voltage source 15, with the aid of which non-thermal gas discharges can be ignited in the reactor 11. In addition to a pulsed or alternating voltage component, the supply voltage may also include a DC voltage component that, in addition to the mechanical deposition, can also effect electrostatic deposition.

Along the gas flow 16, there are regions for preferential soot deposition. If the shape of the electrode geometry is optimized in accordance with the above stipulations, the regions of deposition will also be the preferential regions for the gas discharges to be burned.

As shown in FIG. 2, electrodes 21 are formed by a metallic support structure, which is held at the sides. Functional layers 22, 23, which may have either dielectric or catalytic functions or both functions, are optionally applied to one or both sides of these metallic electrodes 21. Both the thickness and the relative permittivity are crucial to the dielectric properties. These properties can be used together with the local electrode spacing dg in order, in regions 24 with local soot deposition, to enable the plasma to burn in the form of surface and volume discharges of defined properties, such as burning time and current density. The functional layers may also be composed of a plurality of sublayers with different materials properties: in the case of catalytic materials with unfavorable electrical properties, by way of example, thin catalytic films can be applied to thicker dielectric layers.

It is possible to alter the layers along the direction of flow of the exhaust gas: by way of example, a dielectrically active coating with a material having a high relative permittivity or a low thickness may be advantageous in the front part of the reactor, in order to have higher electrical power densities available for lowering the levels of soot in this part, while in the rear part of the reactor the coating should promote a mild volumetric discharge and, therefore, should tend to have a low relative permittivity or a high thickness. Examples of suitable materials are ZrO₂ for a high relative permittivity and Al₂O₃, glass, or enamel for a low relative permittivity. To provide ceramic layers with catalytic properties, it is possible to carry out doping with corresponding materials. Examples of effective oxidation catalysts are precious metals, such as Pt or Pd, while an example of a suitable reduction catalyst in the rear part of the reactor is Ag-doped γ-Al₂O₃.

As a modification to the planar geometry shown in FIG. 1, it is also possible to use cylindrical reactor geometries. An example of such a configuration is shown in FIG. 3. The two half-spaces 31 and 32 are illustrated in cross-section, concentrically with respect to an axis of symmetry, these spacers together forming the rotational symmetrical structure.

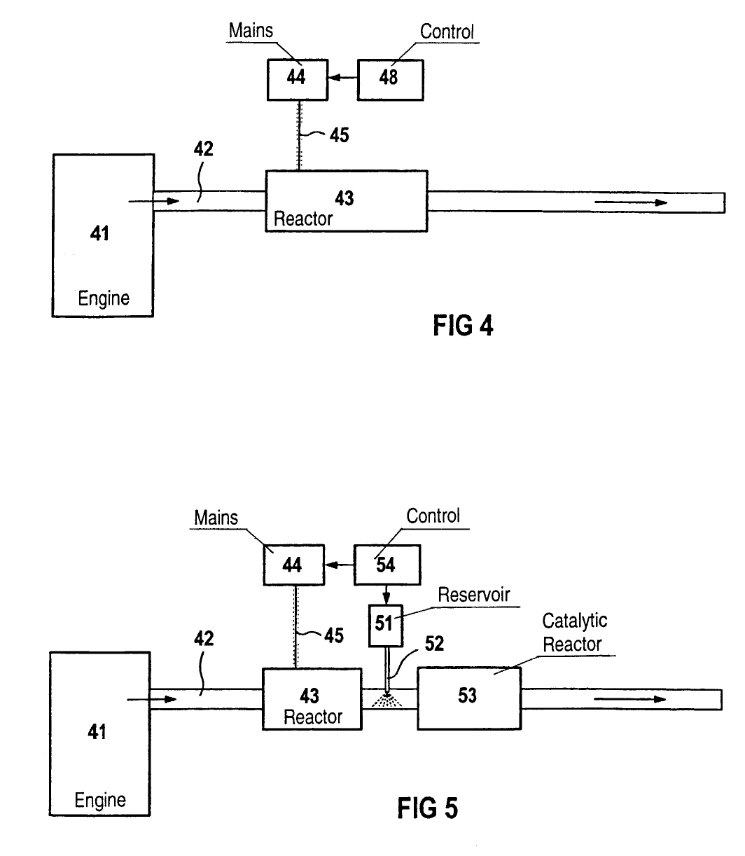

FIG. 4 shows a complete configuration for lowering the level of soot according to the invention: an exhaust section 42, which includes a plasma reactor 43 for lowering the levels of particles, is connected to an internal combustion engine 41. There is an electrical mains part 44 for exciting the non-thermal gas discharges, and the mains part 44 is connected to the reactor 43 by a shielded cable 45, preferably, a coaxial cable, and is assigned a control unit 48. A muffler and exhaust pipe follow the configuration, which are not illustrated in more detail. In such a case, the plasma reactor 43 is simultaneously responsible for the catalytic reduction using carbon-containing reducing agents RM, such as soot and unburnt hydrocarbons.

FIG. 5 shows an alternative configuration for lowering the levels of soot to that shown in FIG. 4. The alternative configuration is combined with selective catalytic reduction of the nitrogen oxides. The nitrogen-containing reducing agent RM is introduced into the exhaust section from a reservoir 51 by a metering device 52 with pump and injector, at a location between the reactor 43 for lowering the level of soot and a catalytic reactor 53. In this case, a control unit 54 controls not only the plasma power required but also, at the same time, the catalytic reduction. For the wavy or folded structure of the electrodes illustrated in FIGS. 1 to 3, it is important to maintain structure parameters. As is self-evident, in particular, from FIG. 1, dw characterizes the width of the discharge and is, therefore, responsible for the physical gas discharge properties. By contrast, the ratio dh/dl is of decisive importance for the level of inertia forces. On the other hand, the field strength increases can be predetermined or suitably set by the ratio dw/dh and/or dw/dl. dw in the range from 0.5 mm<dw<5 mm was investigated in practical tests.

Suitable dimensions are respectively dependent on the individual case. However, the overall result is a self-activating system, which means that with small dimensions and settling of the soot particles, the soot particles are rapidly oxidized. To electrically excite the dielectric barrier discharge, it has proven effective for the pulsed voltage source to be superimposed on a calibration field.

I claim:

1. A method of plasma-induced lowering of soot emission, which comprises:
producing soot particles in an engine exhaust gas flow of a diesel engine through an exhaust section;
integrating a reactor generating dielectric barrier discharges in the exhaust section;
diverting the gas flow and generating the dielectric barrier discharges by providing electrodes in the reactor, the electrodes structured periodically along the exhaust section;
depositing the soot particles flowing along the exhaust section on the periodically structured electrodes as result of the diversion of the gas flow due to inertia forces; and
oxidizing the soot particles deposited on the electrodes by continuous action of the gas discharges.

2. The method according to claim 1, which further comprises assisting the deposition of the soot particles on the electrodes with electrical fields.

3. The method according to claim 1, which further comprises generating the dielectric barrier gas discharges with at least one of the electrodes being a metallic electrode having an electrically insulating, dielectric coating on sides thereof.

4. The method according to claim 1, which further comprises generating the dielectric barrier gas discharges with at least one of the electrodes being a metallic electrode having two sides and an electrically insulating, dielectric coating on the two sides.

5. The method according to claim 1, which further comprises assisting the oxidation of the soot particles with catalytic coatings on the electrodes.

6. The method according to claim 1, which further comprises catalytically reducing nitrogen oxides present in the exhaust gas within the exhaust section and promoting the catalytic reduction with the dielectric barrier gas discharges.

7. The method according to claim 6, which further comprises:
carrying out the catalytic reduction of the nitrogen oxides in the same reactor as the oxidation of the soot particles; and
utilizing carbon compounds as a reducing agent.

8. The method according to claim 6, which further comprises
carrying out the catalytic reduction of the nitrogen oxides in a separate catalytic reactor; and
adding a nitrogen-containing reducing agent to the exhaust gas upstream of the catalytic reactor with respect to a flow direction of the engine exhaust gas flow.

9. A method of plasma-induced lowering of soot emission in a diesel engine producing soot particles in an engine exhaust gas flow through an exhaust section, which comprises:
integrating a reactor generating dielectric barrier discharges in the exhaust section of the diesel engine;
diverting the gas flow and generating the dielectric barrier discharges by providing electrodes in the reactor, the electrodes structured periodically along the exhaust section;
depositing the soot particles flowing along the exhaust section on the periodically structured electrodes as result of the diversion of the gas flow due to inertia forces; and
oxidizing the soot particles deposited on the electrodes by continuous action of the gas discharges.

10. A device for plasma-induced lowering of soot emission of an exhaust gas containing soot particles, comprising:
at least one reactor generating dielectric barrier discharges, said at least one reactor having metal electrodes with at least two sides;
said metal electrodes having:
a dielectric material coating on each of said at least two sides; and
a structure running along the exhaust section for inertia deposition of the soot particles, said structure selected from the group consisting of a wavy structure and a folded structure.

11. The device according to claim 10, wherein said structure has preferential soot deposition locations at which an electrical field strength is increased to generate the dielectric barrier gas discharges.

12. The device according to claim 11, wherein said electrodes have a planar configuration.

13. The device according to claim 10, wherein said electrodes are rotationally symmetrical.

14. The device according to claim 10, wherein:
the exhaust section is circular; and
said electrodes are rotationally symmetrical with respect to the exhaust section.

15. The device according to claim 10, wherein said structure is periodically recurring and is defined by structure parameters along a direction of flow of the exhaust gas.

16. The device according to claim 15, wherein said structure parameters define physical gas discharge properties for the dielectric barrier discharges and inertia properties for the deposition of the soot particles.

17. The device according to claim 10, wherein said coating is of ceramic.

18. The device according to claim 17, wherein said ceramic is based on at least one of the group consisting of zirconium oxide and aluminum oxide.

19. The device according to claim 10, wherein said coating is of one of the group consisting of glass and enamel.

20. The device according to claim 10, wherein a dielectric material of said coating has oxidation promoting catalytic additives.

21. The device according to claim 20, wherein said oxidation promoting catalytic additives are selected from the group consisting of platinum and palladium.

22. The device according to claim 10, wherein a dielectric material of said coating has catalytic additives promoting nitrogen oxide reduction.

23. The device according to claim 22, wherein said catalytic additives are selected from the group consisting of γ-Al₂O₃ and Ag-γ-Al₂O₃.

24. The device according to claim 10, wherein:
said at least one reactor is two separate reactors;
a first of said reactors has a plasma-induced soot emission lowering device; and
a second of said reactors has a catalytic reduction device for nitrogen oxides present in the exhaust gas.

25. The device according to claim 24, including a metering device supplying a nitrogen-containing reducing agent connected upstream of said second reactor with respect to a direction of flow of the exhaust gas.

26. A device for plasma-induced lowering of soot emission, comprising:
at least one reactor generating dielectric barrier discharges, said at least one reactor to be integrated into an exhaust section of a diesel engine producing soot particles in an engine exhaust gas flow, said at least one reactor having metal electrodes diverting the exhaust gas flow and generating the dielectric barrier discharges; and
said metal electrodes having:
at least two sides;
a coating of dielectric material on each of said at least two sides; and
one of a wavy structure and a folded structure running along the exhaust section for inertia deposition of soot on said electrodes, continuous action of the gas discharges on the exhaust gas flow oxidizing the soot particles deposited on said electrodes.
